(19) United States
(12) Patent Application Publication
(10) Pub. No.: US 2006/0047099 A1
(43) Pub. Date: Mar. 2, 2006

(54) Process for the production of polyurethane (meth)acrylates

(76) Inventors: Carmen Flosbach, Wuppertal (DE); Wiebke Becker, Essen (DE); Stefanie Matten, Wuppertal (DE)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/925,843

(22) Filed: Aug. 25, 2004

(51) Int. Cl. C08G 18/10; C08G 18/67; C08L 75/16; B32B 27/30; B32B 27/40

(52) U.S. Cl. 528/75; 528/85; 525/455

(57) ABSTRACT

A process for the production of polyurethane (meth)acrylates, in which a trimer of a (cyclo)aliphatic diisocyanate, 1,6-hexanediisocyanate, a diol component and hydroxy-C2-C4 alkyl (meth)acrylate in the molar ratio 1:x:x:3 are reacted without solvent and without subsequent purification operations, wherein x means any desired value from 1 to 6, wherein the diol component is selected from the group consisting of an individual linear aliphatic alpha,omega C2-C12 diol and a combination of two to four (cyclo)aliphatic diols, wherein in the case of diol combination each of the diols makes up at least 10 mol % of the diols of the diol combination and the diol combination consists to at least 80 mol % of at least one linear aliphatic alpha,omega C2-C12 diol.

### BACKGROUND OF THE INVENTION

The present invention relates to a process for the production of polyurethane (meth)acrylates, to the polyurethane (meth)acrylates produced by the process according to the invention and to powder coating compositions (powder coatings) which contain the polyurethane (meth)acrylates as binders.

### Description of the Prior Art

Polyurethane (meth)acrylates suitable as binders for the production of powder coating compositions are known from WO 01/25306. They are produced by reacting at least one linear aliphatic diisocyanate, at least one aliphatic compound with at least two isocyanate-reactive functional groups and/or water and at least one olefinically unsaturated compound with an isocyanate-reactive functional group. WO 01/25306 recommends performing the reaction in an organic solvent or solvent mixture which is not isocyanate-reactive. The polyurethane (meth)acrylate may then be obtained by evaporation and/or crystallization and/or recrystallization. All the syntheses described in the Examples section of WO 01/25306 proceed in methyl ethyl ketone as the inert solvent, followed by 12 hours cooling at 3° C. of the resultant product solution, from which polyurethane acrylate is isolated as a precipitated solid by suction filtration, washing and vacuum-drying.

While working in the organic solvent does indeed yield products usable as powder coating binders, it is disadvantageous in various respects. The solvent must be completely separated from the product to be used as powder coating binder. Yield is reduced by the purification operations.

Replication of the examples from WO 01/25306 in the absence of organic solvent is problematic either because excessively high melting temperatures must be used, resulting in the risk of thermal free-radical polymerization of the olefinic double bonds, or because products are obtained which are not suitable as powder coating binders because their melting point or melting range is too high or too low. Excessively low melting temperatures do not permit processing to form a powder coating; grinding, for example, is made more difficult or impossible. Excessively high melting temperatures are, for example, incompatible with powder coating processes which comprise a curing process in which lower melting temperatures are specified. Excessively high melting temperatures also often have a negative impact on levelling of the powder coating in the molten state during the curing process.

There was a desire to develop a process for the production of polyurethane (meth)acrylates that are suitable for use as powder coating binders which avoid the above disadvantages.

The process according to the invention was accordingly developed, which proceeds in the absence of solvents and without loss of yield and provides polyurethane (meth)acrylates which, even without purification, may successfully be used as powder coating binders.

### SUMMARY OF THE INVENTION

The process is a process for the production of polyurethane (meth)acrylates in which a trimer of a (cyclo)aliphatic diisocyanate, 1,6-hexanediisocyanate, a diol component and hydroxy-C2-C4 alkyl(meth)acrylate, preferably hydroxy-C2-C4 alkylacrylate, in the molar ratio 1:x:x:3 are reacted without solvent and without subsequent purification operations, wherein x means any desired value from 1 to 6, preferably from 1 to 3, wherein the diol component is an individual linear aliphatic alpha,omega C2-C12 diol or a combination of two to four, preferably two or three, (cyclo)aliphatic diols, wherein in the case of diol combination each of the diols makes up at least 10 mol % of the diols of the diol combination and the diol combination consists of at least 80 mol % of at least one linear aliphatic alpha,omega C2-C12 diol.

x represents any value from 1 to 6 and includes any intermediate values in addition to the corresponding integers.

### DETAILED DESCRIPTION OF THE EMBODIMENTS

In the process according to the invention, the trimer of the (cyclo)aliphatic diisocyanate, 1,6-hexanediisocyanate, diol component and hydroxy-C2-C4 alkyl(meth)acrylate are reacted stoichiometrically with one another in the molar ratio 1 mol trimer of the (cyclo)aliphatic diisocyanate: x mol 1,6-hexanediisocyanate:x mol diol:3 mol hydroxy-C2-C4 alkyl(meth)acrylate, wherein x represents any value from 1 to 6, preferably from 1 to 3. At values of x>6, it is often necessary to use synthesis temperatures which are so high that there is a risk of free-radical polymerization during the synthesis and/or products are obtained which, with regard to use as powder coating binders, have excessively high melting points or ranges, for example, above 130° C. Moreover, it is, in general, not possible to achieve adequate crosslink density with powder coatings formulated with polyurethane (meth)acrylates as binders that have been produced at x>6.

The trimer of the (cyclo)aliphatic diisocyanate is polyisocyanates of the isocyanurate type, prepared by trimerization of a (cyclo)aliphatic diisocyanate. Appropriate trimerization products derived, for example, from 1,4-cyclohexanedimethylenediisocyanate, in particular from isophorondiisocyanate and more particularly from 1,6-hexanediisocyanate, are suitable. The industrially obtainable isocyanurate polyisocyanates generally contain, in addition to the pure trimer, i.e. the isocyanurate made up of three diisocyanate molecules and comprising three NCO functions, isocyanate-functional secondary products with a relatively high molar mass. Products with the highest possible degree of purity are preferably used. In each case the trimers of the (cyclo)aliphatic diisocyanates obtainable in industrial quality are regarded as pure trimer irrespective of their content of said isocyanate-functional secondary products with respect to the molar ratio applicable in the process according to the invention of 1 mol trimer of the (cyclo)aliphatic diisocyanate:x mol 1,6-hexanediisocyanate:x mol diol:3 mol hydroxy-C2-C4 alkyl(meth)acrylate.

An individual linear aliphatic alpha,omega C2-C12 diol or combinations of two to four, preferably of two or three, (cyclo)aliphatic diols are used as the diol component. The diol combination preferably consists of two to four, in particular two or three, linear aliphatic alpha,omega C2-C12 diols.

Examples of an individual linear aliphatic alpha,omega C2-C12 diol or linear aliphatic alpha,omega C2-C12 diols which can be used within the diol combination are ethylene glycol, 1,3-propanediol, 1,4-butanediol, 1,5-pentanediol, 1,6-hexanediol, 1,10-decanediol, 1,12-dodecanediol.

Examples of (cyclo)aliphatic diols which can be used within the diol combination in addition to the at least one linear aliphatic alpha,omega C2-C12 diol making up at least 80 mol % of the diol combination are the further isomers of propane and butane diol, different from the isomers of propane and butane diol cited in the preceding paragraph, and neopentylglycol, butylethylpropanediol, the isomeric cyclohexane diols, the isomeric cyclohexanedimethanols, hydrogenated bisphenol A and tricyclodecanedimethanol.

In the case of the diol combination, the mixture of the diols making up the combination can be used in the synthesis process according to the invention or the diols making up the diol combination are each used individually in the synthesis. It is also possible to use a portion of the diols as a mixture and the remaining fraction(s) in the form of pure diol.

In the case of the diol combination, preferred diol combinations totalling 100 mol % in each case are combinations of 10 to 90 mol % 1,3-propanediol with 90 to 10 mol % 1,5-pentanediol, 10 to 90 mol % 1,3propanediol with 90 to 10 mol % 1,6-hexanediol and 10 to 90 mol % 1,5-pentanediol with 90 to 10 mol % 1,6-hexanediol.

Preferably, only one hydroxy-C2-C4-alkyl (meth)acrylate is used in the process according to the invention. Examples of hydroxy-C2-C4-alkyl (meth)acrylates are hydroxyethyl (meth)acrylate, one of the isomeric hydroxypropyl (meth)acrylates or one of the isomeric hydroxybutyl (meth)acrylates; the acrylate compound is preferred in each case.

In the process according to the invention the trimer of the (cyclo)aliphatic diisocyanate, 1,6-hexane-diisocyanate, diol component and hydroxy-C2-C4 alkyl (meth)acrylate are reacted together without solvents. The reactants may here all be reacted together simultaneously or in two or more synthesis stages. Synthesis procedures in which hydroxy-C2-C4 alkyl (meth)acrylate or diol component and the trimer of the (cyclo)aliphatic diisocyanate alone are reacted with one another are preferably avoided.

When the synthesis is performed in multiple stages, the reactants may be added in the most varied order, for example, also in succession or in alternating manner. For example, 1,6-hexanediisocyanate may be reacted initially with a mixture of the hydroxyl functional components and then with the trimer of the (cyclo)aliphatic diisocyanate or a mixture of the isocyanate functional components with the hydroxyl functional components or a mixture of the isocyanate functional components initially with hydroxy-C2-C4 alkyl(meth)acrylate and then with the diol component. In the case of a diol combination, the diol component may, for example, also be divided into two or more portions, for example, also into the individual (cyclo)aliphatic diols. The individual reactants may in each case be added in their entirety or in two or more portions.

The reaction is exothermic and proceeds at a temperature above the melting temperature of the reaction mixture, but below a temperature, which results in free-radical polymerization of the (meth)acrylate double bonds.

The reaction temperature is, for example, 60 to a maximum of 130° C. The rate of addition or quantity of reactants added is accordingly determined on the basis of the degree of exothermy and the liquid (molten) reaction mixture may be maintained within the desired temperature range by heating or cooling.

Once the reaction is complete and the reaction mixture has cooled, solid polyurethane (meth)acrylates with number average molar masses in the range of 1,500 to 4,000 (determined by gel permeation chromatography, polystyrene gel crosslinked with divinylbenzene as the stationary phase, tetrahydrofuran as the liquid phase, polystyrene standards) are obtained. The polyurethane (meth)acrylates do not require working up and may be used directly as a powder coating binder. Their melting temperatures are in particular in the range from 80 to 130° C.; in general, the melting temperatures are not sharp melting points, but instead the upper end of melting ranges with a breadth of, for example, 30 to 90° C.

The polyurethane (meth)acrylates may be used in powder coatings not only as the sole binder or as the main binder constituting at least 50 wt. % of the resin solids content, but also in smaller proportions as a co binder. The high acid resistance and also, in general, good scratch-resistance of the coating films applied and cured from the powder coatings is remarkable.

The powder coatings produced with the polyurethane (meth)acrylates produced according to the invention as the powder coating binders may comprise powder coatings curable exclusively by the free-radical polymerization of olefinic double bonds, which cure thermally or by irradiation with high-energy radiation, in particular, UV radiation. They may, however, also comprise “dual-cure” powder coatings, which additionally cure by means of a further, in general thermally induced crosslinking mechanism.

Depending on the nature of the powder coatings, the resin solids content thereof may apart from the polyurethane (meth)acrylates produced according to the invention also contain additional binders and/or crosslinking agents. The additional binders and/or crosslinking agents may here be curable thermally and/or by irradiation with high-energy radiation.

While thermally curable powder coatings contain thermally cleavable free-radical initiators, the powder coatings curable by UV irradiation contain photoinitiators.

Depending on the selected curing conditions (purely thermal curing or a combination of UV irradiation and thermal curing), dual-cure powder coatings may contain thermally cleavable free-radical initiators or photoinitiators.

Examples of thermally cleavable free-radical initiators are azo compounds, peroxide compounds and C—C-cleaving initiators.

Examples of photoinitiators are benzoin and derivatives thereof, acetophenone and derivatives thereof, such as, for example, 2,2-diacetoxyacetophenone, benzophenone and derivatives thereof, thioxanthone and derivatives thereof, anthraquinone, 1-benzoylcyclohexanol, organophosphorus compounds, such as, for example, acyl phosphine oxides.

The initiators for curing by free-radical polymerization are used, for example, in proportions of 0.1 to 7 wt. %, preferably of 0.5 to 5 wt. %, relative to the total of resin solids content and initiators. The initiators may be used individually or in combination.

Apart from the already stated initiators, the powder coatings may contain additional conventional coating additives, for example, inhibitors, catalysts, levelling agents, degassing agents, wetting agents, anticratering agents, antioxidants and light stabilizers. The additives are used in conventional amounts known to the person skilled in the art.

The powder coatings may also contain transparent pigments, color-imparting and/or special effect-imparting pigments and/or fillers (extenders), for example, corresponding a pigment plus filler: resin solids content ratio by weight in the range from 0:1 to 2:1. Examples of inorganic or organic color-imparting pigments are titanium dioxide, iron oxide pigments, carbon black, azo pigments, phthalocyanine pigments, quinacridone or pyrrolopyrrole pigments. Examples of special effect-imparting pigments are metal pigments, for example, made from aluminum, copper or other metals; interference pigments, such as, for example, metal oxide coated metal pigments, for example, titanium dioxide coated or mixed oxide coated aluminum, coated mica, such as, for example, titanium dioxide coated mica. Examples of usable fillers are silicon dioxide, aluminum silicate, barium sulfate, calcium carbonate and talcum.

The powder coatings may be produced using the conventional methods known to the person skilled in the art, in particular, for example, by extruding the powder coating, which has already been completely formulated by dry mixing of all the required components, in the form of a pasty melt, cooling the melt, performing coarse comminution, fine grinding and then sieving to the desired grain fineness, for example, to average particle sizes of 20 to 90 μm.

The powder coatings may be used for any desired industrial coating purpose and are applied using conventional methods, preferably by spraying. Substrates which may be considered are in particular not only metal substrates but also plastic parts, for example, also fibre-reinforced plastic parts. Examples are automotive bodies and body parts, such as, for example, body fittings.

The powder coatings preferably comprise powder clear coating compositions, which are used to produce an outer powder clear coat layer on a color- and/or special effect-imparting base coat layer. For example, a color- and/or special effect-imparting base coat layer may be applied onto automotive bodies provided with a conventional precoating and optionally cured and thereafter, a powder clear coat layer of the powder clear coating composition may be applied and cured. If the base coat layer is not cured before application of the powder clear coat, the powder clear coat is applied by the “wet-on-wet” process.

The method used to apply the powder coatings may be, for example, initially to apply the powder coating onto the particular substrate and to melt it by heating the applied powder coating to a temperature above the melting temperature, for example, in the range from 80 to 150° C. After melting with exposure to heat, for example, by convective and/or radiant heating, and an optionally provided phase to allow for levelling, curing may proceed by irradiation with high-energy radiation and/or by supply of thermal energy. UV radiation or electron beam radiation may be used as high-energy radiation. UV radiation is preferred.

The following examples illustrate the invention. As used below, “pbw” means parts by weight.

### EXAMPLES

### Examples 1a to 1i

### Preparation of Polyurethane Diacrylates for Comparison Purposes

Polyurethane diacrylates were produced by reacting 1,6-hexane diisocyanate with diols and hydroxyalkyl acrylate in accordance with the following general synthesis method:

1,6-hexane diisocyanate (HDI) was initially introduced into a 2 litre four-necked flask equipped with a stirrer, thermometer and column and 0.1 wt. % methylhydroquinone and 0.01 wt. % dibutyltin dilaurate, in each case relative to the initially introduced quantity of HDI, were added. The reaction mixture was heated to 60° C. Hydroxyalkyl acrylate was then apportioned in such a manner that the temperature did not exceed 80° C. The reaction mixture was stirred at 80° C. until the theoretical NCO content had been reached. Once the theoretical NCO content had been reached, the diols A, B, C were added one after the other, in each case in a manner such that a temperature of 75 to 120° C. was maintained. In each case, the subsequent diol was not added until the theoretical NCO content had been reached. The reaction mixture was stirred at 120° C. until no free isocyanate could be detected. The hot melt was then discharged and allowed to cool.

The melting behavior of the resultant polyurethane diacrylates was investigated by means of DSC (differential scanning calorimetry, heating rate 10 K/min).

Comparative examples 1a to 1i are shown in Table 1. The Table states which reactants were reacted together in what molar ratios and the result which was achieved. In particular, the final temperature of the melting process measured by DSC is stated in ° C.

TABLE 1

| | | Moles | | | | |
|---|---|---|---|---|---|---|
| | Moles | Hydroxyalkyl | Moles | Moles | Moles | |
| Example | HDI | acrylate | Diol A | diol B | diol C | Results |
| 1a | 2 | 2 HEA | 0.8 NPG | 0.2 HEX | | 90° C.; grindable |
| | | | | | | chilled |
| 1b | 3 | 2 HEA | 1.7 NPG | 0.3 HEX | | 88° C.; grindable |
| | | | | | | chilled |
| 1c | 3 | 2 HEA | 1.5 NPG | 0.5 HEX | | 99° C.; grindable |
| 1d | 4 | 2 HEA | 2.2 NPG | 0.8 HEX | | 100° C.; grindable |
| 1e | 3 | 2 HBA | 0.7 MPD | 0.7 PENT | 0.6 DEK | 117° C.; grindable |
| 1f | 3 | 2 HBA | 1 CHDM | 1 PROP | | 118° C.; grindable |
| 1g | 3 | 2 HBA | 1.3 CHDM | 0.7 PENT | | 120° C.; grindable |
| 1h | 3 | 2 HPA | 1 CHDM | 0.5 PROP | 0.5 PENT | 118° C.; grindable |
| 1i | 3 | 2 HPA | 0.6 HEX | 0.7 PENT | 0.7 PROP | 112° C.; grindable |

HDI: 1,6-hexane diisocyanate
HBA: 4-hydroxybutyl acrylate
HEA: hydroxyethyl acrylate
HPA: 2-hydroxypropyl acrylate
CHDM: 1,4-cyclohexanedimethanol
DEK: 1,10-decanediol
HEX: 1,6-hexanediol
MPD: 2-methyl-1,3-propanediol
NPG: neopentyl glycol
PENT: 1,5-pentanediol
PROP: 1,3-propanediol

### Examples 2a to 2m

### Preparation According to the Invention of Polyurethane Acrylates

Polyurethane acrylates were produced by reacting a trimer of a (cyclo)aliphatic diisocyanate, HDI, diol component and hydroxyalkyl acrylate in accordance with the following general synthesis method:

A mixture of a trimer of a diisocyanate and HDI was initially introduced into a 2 litre four-necked flask equipped with a stirrer, thermometer and column and 0.1% by weight methylhydroquinone and 0.01% by weight dibutyl tin dilaurate, in each case based on the quantity of isocyanate introduced, were added. The reaction mixture was heated to 60° C. A mixture of hydroxyalkyl acrylate and diol(s) was then added such that 110° C. was not exceeded. The temperature was carefully increased to a maximum of 130° C. and the mixture stirred until no more free isocyanate could be detected. The hot melt was then discharged and allowed to cool.

The melting behavior of the resultant polyurethane acrylates was investigated by means of DSC (heating rate 10 K/min).

Examples 2a to 2m according to the invention are shown in Table 2. The table states which reactants were reacted together and in which molar ratios and the result which was achieved. In particular, the final temperature of the melting process measured using DSC is indicated in ° C.

TABLE 2

| | Mols of | | Mols | | | |
|---|---|---|---|---|---|---|
| | trimeric | Mols | of hydroxyalkyl | Mols | Mols | |
| Example | diisocyanate | of HDI | acryate | of diol A | of diol B | Results |
| 2a | 1 t-HDI | 3 | 3 HPA | 3 PROP | | 115° C.; |
| | | | | | | grindable |
| 2b | 1 t-HDI | 3 | 3 HPA | 1.5 PROP | 1.5 PENT | 112° C.; |
| | | | | | | grindable |
| 2c | 1 t-HDI | 3 | 3 HPA | 2.5 PROP | 0.5 PENT | 111° C.; |
| | | | | | | grindable |
| 2d | 1 t-HDI | 3 | 3 HEA | 2.5 PROP | 0.5 DEC | 110° C.; |
| | | | | | | grindable |
| 2e | 1 t-HDI | 2 | 3 HPA | 1 PROP | 1 HEX | 95° C.; |
| | | | | | | grindable |
| 2f | 1 t-HDI | 2 | 3 HBA | 2 PENT | | 100° C.; |
| | | | | | | grindable |
| 2g | 1 t-HDI | 2 | 3 HEA | 2 HEX | | 120° C.; |
| | | | | | | grindable |
| 2h | 1 t-IPDI | 2 | 3 HBA | 2 HEX | | 130° C.; |
| | | | | | | grindable |
| 2i | 1 t-HDI | 2.5 | 3 HPA | 2.5 PROP | | 110° C.; |
| | | | | | | grindable |
| 2k | 1 t-HDI | 3 | 3 HEA | 3 HEX | | 119° C.; |
| | | | | | | grindable |
| 2l | 1 t-HDI | 2.5 | 3 HEA | 2.5 HEX | | 118° C.; |
| | | | | | | grindable |
| 2m | 1 t-IPDI | 2 | 3 HBA | 2 PENT | | 125° C.; |
| | | | | | | grindable |

t-HDI; trimeric hexanediisocyanate, Desmodur ® N3600 from Bayer
t-IPDI; trimeric isophorondiisocyanate, Vestanat ® T-1890 from Hüls
cf. Table 1 for further abbreviations.

### Examples 3a to 3s

Powder coating compositions were prepared, applied and cured with the polyurethane diacrylate binders of comparative examples 1a to 1i and with the polyurethane acrylate binders of examples 2a to 2m according to the invention using the following general instructions:

A comminuted mixture of the following components was premixed and extruded

| | |
|---|---|
| 96.5 | pbw of one of the polyurethane diacrylates of Examples 1a |
| | to 1i or of one of the polyurethane acrylates of Examples |
| | 2a to 2m, |
| 1 | pbw of Irgacure ® 2959 (photoinitiator from Ciba), |
| 0.5 | pbw of Powdermate ® 486 CFL (levelling additive from |
| | Troy Chemical Company), |
| 1 | pbw of Tinuvin ® 144 (HALS light stabilizer from Ciba) and |
| 1 | pbw of Tinuvin ® 405 (UV absorber from Ciba) |

to produce a powder clear coat composition in conventional manner after cooling, crushing, grinding and sieving.

The respective powder clear coats were sprayed, in a layer thickness of 80 μm in each case, onto steel sheets coated with commercially available electrodeposition paint, filler and base coat (flashed off), melted for 10 min at 140° C. (oven temperature) and cured by UV irradiation corresponding to a radiation intensity of 500 mW/cm² and a radiation dose of 800 mJ/cm². The coatings obtained were investigated with respect to their scratch resistance and acid resistance. The results are shown in Table 3.

TABLE 3

| | | Scratch | |
|---|---|---|---|
| | | resistance¹⁾ | Acid resistance²⁾ |
| Example | Binder example | (residual gloss, %) | (minutes) |
| 3a | 1a | 72 | 12 |
| 3b | 1b | 68 | 13 |
| 3c | 1c | 71 | 11 |
| 3d | 1d | 69 | 12 |
| 3e | 1e | 75 | 10 |
| 3f | 1f | 60 | 22 |
| 3g | 1g | 56 | 24 |
| 3h | 1h | 58 | 23 |
| 3i | 1i | 82 | 13 |
| 3k | 2a | 81 | >30 |
| 3l | 2b | 79 | >30 |
| 3m | 2c | 79 | >30 |
| 3n | 2d | 82 | >30 |
| 3o | 2e | 81 | >30 |
| 3p | 2f | 80 | >30 |
| 3q | 2g | 84 | >30 |
| 3r | 2h | 58 | >30 |
| 3s | 2i | 78 | >30 |
| 3t | 2k | 85 | >30 |
| 3u | 2l | 82 | >30 |
| 3v | 2m | 56 | >30 |
| ¹⁾Scratch resistance was determined in terms of residual gloss after wash scratching. Residual gloss was measured in % (ratio of initial gloss of the clear coat surface to its gloss after wash scratching, gloss measurement in each case being performed at an angle of illumination of 20°). Wash-scratching was performed using an Amtec Kistler laboratory car wash system (c.f. Th. Klimmasch | | | |
| # and Th. Engbert, Entwicklung einer einheitlichen Laborprüfmethode für die Beurteilung der Waschstraβenbeständigkeit von Automobil-Decklacken [development of a standard laboratory test method for evaluating resistance of automotive top coats to car wash systems], in DFO proceedings 32, pages 59 to 66, technology seminars, proceedings of the seminar on 29-30.4.97 in | | | |
| # car wash Cologne, published by Deutsche Forschungsgesellschaft für Oberflächenbehandlung e.V., Adersstraβe 94, 40215 Düsseldorf). | | | |

²⁾Acid test: 50 μl respectively of 36% sulphuric acid were dropped onto the paint film for 30 minutes at intervals of one minute, at 65° C. Assessment: destruction of the film after X (0 to 30) minutes

The powder clear coats prepared on the basis of the polyurethane acrylate binders of examples 2a to 2m prove, in particular, to be more acid resistant and, in general, also more scratch resistant than the powder clear coats prepared on the basis of the polyurethane diacrylate binders of examples 1a to 1i.

What is claimed is:

1. A process for the production of polyurethane (meth)acrylates which comprises reacting a trimer of a (cyclo)aliphatic diisocyanate, 1,6-hexanediisocyanate, a diol component and hydroxy-C2-C4 alkyl (meth)acrylate in a molar ratio 1:x:x:3 without solvent and without subsequent purification operations, wherein x is a value from 1 to 6, wherein the diol component is selected from the group consisting of an individual linear aliphatic alpha,omega C2-C12 diol and a diol combination comprising two to four (cyclo)aliphatic diols, wherein each of the diols consist of at least 10 mol % of the diols of the diol combination and wherein the diol combination itself consists of at least 80 mol % of at least one linear aliphatic alpha,omega C2-C12 diol.

2. The process of claim 1, wherein x is any value from 1 to 3.

3. The process of claim 1, wherein the trimer of the (cyclo)aliphatic diisocyanate is derived from a diisocyanate selected from the group consisting of 1,4-cyclohexanedimethylenediisocyanate, isophorondiisocyanate and 1,6-hexanediisocyanate.

4. The process of claim 1, wherein the diol combination consists of two to four linear aliphatic alpha,omega C2-C12 diols.

5. The process of claim 1, wherein the linear aliphatic alpha,omega C2-C12 diol(s) are selected from the group consisting of ethylene glycol, 1,3-propanediol, 1,4-butanediol, 1,5-pentanediol, 1,6-hexanediol, 1,10-decanediol and 1,12-dodecanediol.

6. Polyurethane (meth)acrylates produced according to the process of claim 1.

7. Powder coating compositions comprising the polyurethane (meth)acrylates produced according to the process of claim 1, as binders.
